(19) United States
(12) Patent Application Publication
(10) Pub. No.: US 2006/0047982 A1
(43) Pub. Date: Mar. 2, 2006

(54) Mult-interface auto-switch circuit and memory device with dual interface auto-switch circuit

(75) Inventors: Hai Cha Lo, Taipei City (TW); Yao Wen Hsu, Tainan City (TW); Feng Hsi Lin, Shulin City (TW)

Correspondence Address: TROXELL LAW OFFICE PLLC;SUITE 1404, 5205 LEESBURG PIKE, FALLS CHURCH, VA, 22041, US

(73) Assignee: Incomm Technologies Co., Ltd.

(21) Appl. No.: 11/041,951

(22) Filed: Jan. 26, 2005

(30) Foreign Application Priority Data
Aug. 27, 2004 (TW) 093125704

(51) Int. Cl. G06F 1/26

(52) U.S. Cl. 713/300

(57) ABSTRACT

This invention is related to a multi-interface auto-switch circuit which can be implanted in a memory device. This memory device can use either the first interface or the second interface to communicate with an external device. The multi-interface auto-switch circuit comprises a power detecting and supplying module and an interface switch circuit. The power detecting and supplying module detects and receives the voltage signal from the external device and generates a corresponding electrical signal. The interface switch circuit, which connects to the power detecting and supplying module, receives the corresponding electrical signal and is controlled to connect either the first or the second interface with the external device according to the corresponding electrical signal.

### BACKGROUND OF INVENTION

1. Field of the Invention

This invention is related to a dual interface auto-switch circuit. In particularly, this invention is related to a device which implanted in a flash memory device which includes the USB/SD interfaces. Through detecting a voltage signal, this dual interface auto-switch circuit can determine either the first interface or the second interface to be connected to the external device.

2. Description of the Prior Art

Nowadays, a variety of portable memory devices and peripherals are developed and widely used. For example, the portable memory device can be USB Flash Disk, Compact Flash Card (CF card), Memory Stick (MS card), Secure Digital (SD card), Multi-Media Card (MMC), xD Card, Micro Hard Disk which have either CF or USB interface, and a hard disk located at the external portable box which have USB or PCMCIA interface, etc. These portable memory devices enhance the convenience of user.

The conventional portable memory device includes a non-volatile memory array, a memory controller, and an I/O interface. The non-volatile memory array is used for storing the data and preserves the data without an external power supply. Therefore, the non-volatile memory array is usually made by a flash memory. Of course, the designer can replace the hard disk with the non-volatile memory array. The memory controller includes a circuit, a communication interface and a driving mechanism for driving and accessing the non-volatile memory array. The driving mechanism can be implemented by a hardware (command sequencer circuit) which executes corresponding micro-code or by micro-controller/micro-processor which executes corresponding firmware stored in the controller portable memory device. The communication interface of the portable memory device used a corresponding protocol to communicate with an external device.

Please refer to FIG. 1. FIG. 1 illustrates a block diagram of a conventional flash memory card and a computer. The conventional Flash memory card 11 can not directly communicate with the computer 12 because the computer 12 doesn't have the connector and/or the communication protocol for the conventional Flash memory card 11. In order to communicate with the computer 12, the Flash memory card 11 needs to plug in an external card reader 13 which has a USB interface to communicate with the computer 12 via the external card reader 13. The external card reader 13 not only has the first interface connector 131 for the computer 12, such as the USB connector, and the second interface connector 132 for the Flash Memory card 11, but also a format converter circuit 133 for converting the first format of data received by the first interface connector 131 into the second format of data accepted by the computer 12, such as the USB format. This would be inconvenient for users and the cost would be higher.

In order for improving the convenience, a type of Flash Memory Card which combines the USB and the memory card interface is developed. For example, U.S. Pat. Nos. 6,658,516 and 6,385,677 disclose a dual interface memory card which has both the USB and the SPI interfaces. However, because the connectors of the USB interface and the memory card interface are different, a converting module is needed when this dual interface memory card connects to the USB connector of a computer.

In additions, U.S. Pat. Nos. 6,676,420 and 6,567,273 disclose a dual interface memory in which the USB interface and the memory card interface are developed. Because these two interfaces are implanted directly on the memory card, no converting module is needed while connecting this memory card to the computer.

However, the commercial available dual interface memory cards such as those disclosed in U.S. Pat. Nos. 6,658,516, 6,385,677, 6,676,420, and 6,567,273 use the protocol signal or clock signal input from the external device to determine which, USB or memory card, interface should be used. Because the electrical characteristic of the USB interface is very different from that of the memory card interface, it is hard to detect and compare the protocol signal and/or clock signal. Therefore, the detecting circuit of the conventional dual interface memory card is complicate and the cost is relatively high.

In additions, because two sets of interface circuits are set in the dual interface memory card, both sets of circuits will be activated during the operation of the dual interface memory card and the dual interface memory card will be high power consumption. Therefore, there is room for improvement.

### SUMMARY OF INVENTION

It is therefore one of the objectives of the claimed invention to provide a dual-interface auto-switch circuit located at a memory device. The dual-interface auto-switch circuit is used for detecting a power voltage from an external device to determine one of the dual-interface to be used to communicate with the external device. This invention can simplify the design of the circuit and reduce the cost.

It is therefore one of the objectives of the claimed invention to provide a dual-interface auto-switch circuit located at a memory device. At the same moment, only one interface is activated, whereas the other interface is inactive. Since the inactive interface does not consume power, the total power consumption can be reduced.

It is therefore one of the objectives of the claimed invention to provide a method for auto-switching the interface of the dual-interface memory device. By detecting a power voltage from an external device, which interface should be used for communicating can be determined. In additions, only one interface circuit is activated and the other interface circuit is inactive such that the total power consumption can be reduced.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

The details of the present invention will be more readily understood from a detailed description of the preferred embodiments taken in conjunction with the following figures.

FIG. 1 shows a block diagram of a conventional flash memory card and a computer;

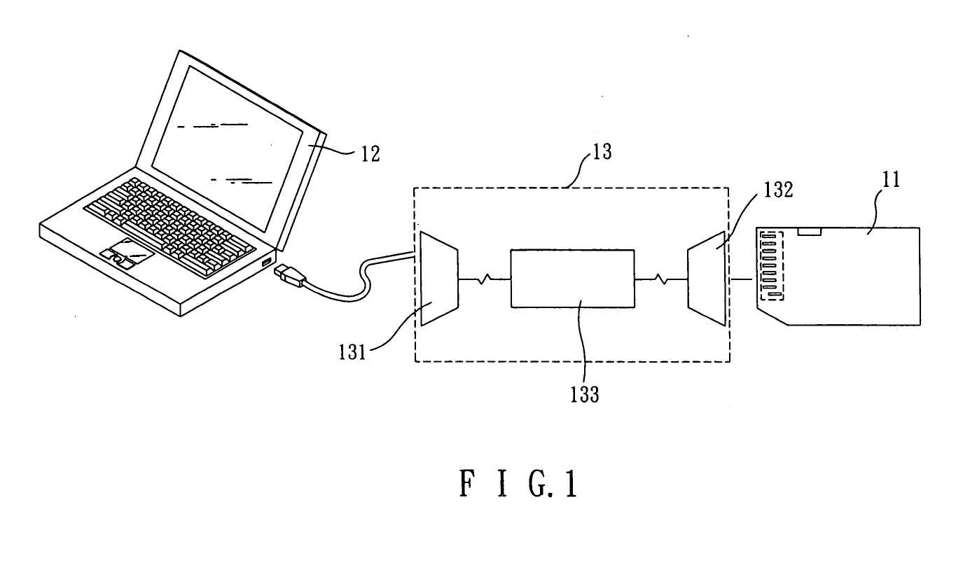

FIG. 2 shows a block diagram of an embodiment of the memory device with a dual-interfaces auto-switch circuit according to the present invention and a computer;

FIG. 3 shows a detailed block diagram of a first embodiment of the dual-interfaces auto-switch circuit according to the present invention;

FIG. 4 illustrates an appearance of a Reduce MultiMedia Card (RS MMC);

FIG. 5 illustrates an appearance of the mini Secure Digital Card (mini SD);

FIG. 6 illustrates a flowchart of an embodiment of a dual-interfaces auto-switch circuit according to the present invention; and

FIG. 7 illustrates a block diagram of a second embodiment of a dual-interfaces auto-switch circuit according to the present invention.

### DETAILED DESCRIPTION

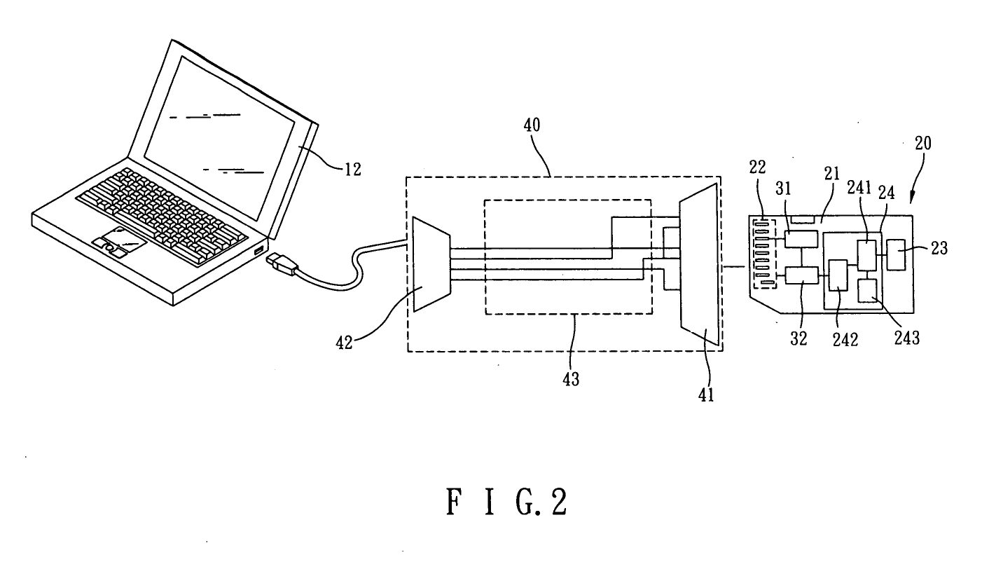

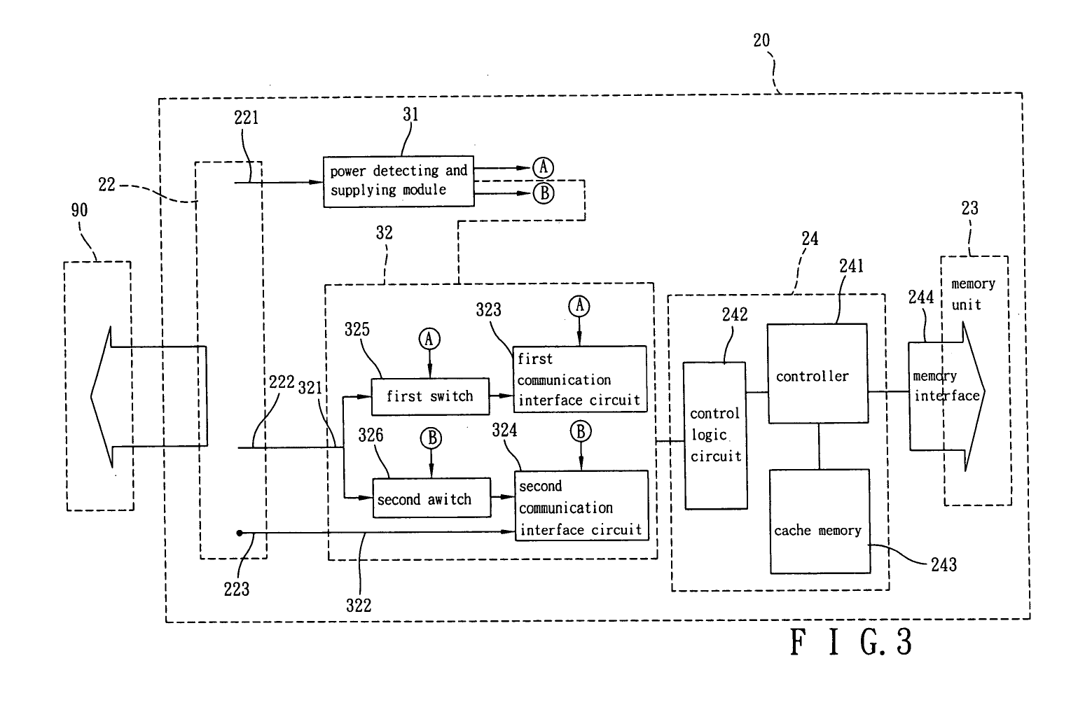

Please refer to FIG. 2 and FIG. 3. FIG. 2 and FIG. 3 show an embodiment of the dual-interface auto-switch circuit and the memory device 20 which comprises the dual interface auto-switch circuit. FIG. 2 shows a block diagram of an embodiment of the memory device with a dual-interfaces auto-switch circuit according to the present invention and a computer. FIG. 3 shows a detailed block diagram of a first embodiment of the dual-interfaces auto-switch circuit according to the present invention.

As shown in FIG. 2 and FIG. 3, the memory device 20 of this invention comprises a body 21, connection pins 22, a memory unit 23, a control unit 24, and the dual interface auto-switch circuit of this invention. The dual interface auto-switch circuit of this invention comprises a power detecting and supplying module 31 and an interface switch circuit 32.

The size of the body 21 fits the size of the flash memory card. In this embodiment, the memory device 20 is a Secure Digital Card (SD). The connection pins 22 are also fit the size of the SD. The memory device 20 of this invention can also be, but not limit to, the Multimedia Card (MMC), Compact Flash (CF), Memory Stick (MS), xD Card, etc.

The connection pins 22 are located on the frontal margin of the body 21 and are exposed externally. Through the connection pins 22, the memory device 20 of this invention can electronically connect to and communicate with an external device 90. The external device 90 can be a card reader, a digital camera, a PDA, a printer, or a computer with the connector of the memory card this invention. The connection pins 22 comprise a supply voltage pin 221 (VBUS/INSS), a plurality of the shared pins 222, and a plurality of the non-shared pins 222. The supply voltage pin 221 (VBUS/IVSS) is for receiving the power supply signal. The plurality of the shared pins 222 are for both interfaces. The plurality of the non-shared pins 222 are for only one interface.

The memory unit 23 is implanted in the body 21. The memory unit 23 is composed of a non-volatile memory array for storing data. For example, in the embodiment, the memory unit 23 comprises at least one flash memory. It can also be a read only memory (ROM) or other type of memories.

The control unit 24 is implanted in the body 21 and connected to the memory unit 23. The control unit 24 can drive the memory unit 23, read the data from the memory unit 23, write data into the memory unit 23, and communicate with the external device 90 through the connection pins 22. In this embodiment, the control unit 24 also comprises a controller 241, a control logic circuit 242, a cache memory 243, and a memory interface 244. The controller 241 and the corresponding firmware control the data transporting and processing. The control logic circuit 242 connects between the controller 421 and the interface switch circuit 32. The data from the interface switch circuit 32 is processed by the control logic circuit 242 and, then, is stored in the memory unit 23 through the memory interface 244. The data stored in the memory unit 23 can also be processed by the controller 241 and, then, transported to the pins 22 through the interface switch circuit 32. The cache memory 243 can speed up the data processing.

The power detecting and supplying module 31 connects to the supply voltage pin 221 of connection pins 22. The power detecting and supplying module 31 can receive and detect a voltage comes from the supply voltage pin 221 and generate an electrical signal in corresponding to the received voltage from the supply voltage pin 221. In this embodiment, the power detecting and supplying module 31 can compare the received voltage with a predetermined value and transfer the received voltage signal into either a first power signal A or a second power signal B according to the result of the comparison. The electrical signal mentioned previously is either the first power signal A or the second power signal B.

Generally speaking, the supply voltage of the USB interface is 5.0 voltage, whereas the supply voltage of the memory card such as SD and MMC is 3.3 voltage or lower. This invention sets a value between 3.3 and 5.0 as the predetermined value for the power detecting and supplying module 31. For example, the predetermined value is set as 4.2 or as other value between 3.3 and 5.0. Thus, by comparing the supply voltage comes from the supply voltage pin 221 with the predetermined value, which is 4.2 in this case, whether the external device 90 uses the USB interface or other memory card interface can be detected. In other words, if the supply voltage form the supply voltage pin 221 is greater than the predetermined value, the external device 90 is connected to the USB interface.

The interface switch circuit 32 connects to the power detecting and supplying module 31, and serially connects between the control unit 24 and the connection pins 22. The interface switch circuit 32 can receive the first power signal A and the second power signal B, which are also known as the electrical signal, and switch to connect either the first communication interface or the second communication interface to the control unit 24 and to communicate with the control unit 24 through the connection pins 22. In this embodiment, the first communication interface is the computer interface, such as a USB interface, whereas the second communication interface is the memory card interface, such as the interface of SD, MMC, CF, MS, xD, etc.

As shown in FIG. 3, the interface switch circuit 32 also includes a plurality of shared signal line 321, a plurality of non-shared signal line 322, a first communication interface circuit 323 which is a USB interface circuit, a second communication interface circuit 324 which is a memory card interface circuit, a first switch 325 and a second switch 326. The plurality of shared signal lines 321 connect to the plurality of the shared pins 222 of the connection pins 22. Both the first communication interface circuit 323 and the second communication interface circuit 324 transfer data through the plurality of the shared lines 321. The plurality of non-shared signal lines 322 connect to the plurality of the non-shared pins 223 of the connection pins 22. Only the second communication interface circuit 324 transfers data through the plurality of the non-shared lines 322. The first communication interface circuit 323 is for processing the data of the first communication interface and converting the data to a first converted signal that can be processed by the control unit 24. The second communication interface circuit 324 is for processing the data of the second communication interface and converting the data to a second converted signal that can be processed by the control unit 24. The plurality of the non-shared lines 322 connect to the second communication interface circuit 324. The first switch 325 connects to the power detecting and supplying module 31 and connects between the plurality of shared lines 321 and the first communication interface circuit 323. The first switch 325 received the first power signal A to determine if the connection between the plurality of the shared lines 321 and the first communication interface circuit 323 should be on. The first switch 325 connects to the power detecting and supplying module 31 and connects between the plurality of shared lines 321 and the first communication interface circuit 323. The second switch 326 connects to the power detecting and supplying module 31 and connects between the plurality of shared lines 321 and the second communication interface circuit 324. The second switch 326 receives the second power signal B to determine if the connection between the plurality of the shared lines 321 and the first communication interface circuit 324 should be on. At any time, the power detecting and supplying module 31 can generate only one of the first power signal A or the second power signal B. In consequence, at any moment, the only one of the first switch 325 or the second switch 326 is turned on. Therefore, at any moment, the memory device 20 of this invention can process and transfer data through only one of the first communication interface circuit 323 or the second communication interface circuit 324. The purpose of auto-switch of the dual interface can be achieved.

In this embodiment, the first power signal A also supplies the power to the first communication interface circuit 323. The second power signal B also supplies the power to the second communication interface circuit 324. Therefore, at any moment, only one of the first communication interface circuit 323 or the second communication interface circuit 324 is supplied the power and is driven. At this moment, the other communication interface circuit is grounded. In other words, the power detecting and supplying module 31 not only provides the control signal to control the operation of the first switch 325 and the second switch 326 , but also provides the power to drive only one of the first communication interface circuit 323 and the second communication interface circuit 324. The communication interface circuit which is not driven is grounded. Thus, the power consumption of the memory device 20 can be reduced.

As shown in FIG. 2, because both the body 21 and the connection pins 22 of the memory device 20 of this invention fit the specification of the memory card interface, the memory device 20 can directly communicate with the external device 90 which has the memory card interface. To connect the memory device 20 to the computer 12 or other USB interface external devices, a flash memory card adapter 40 is needed. In this embodiment, the flash memory card adapter 40 comprises a memory card connector 41, the USB connector 42, and the switch circuit 43. The memory card connector 41 provides sockets for the memory device 2() to plug in and is electrically coupled with the connection pins 22. The USB connector 42 can connect to external devices with USB sockets (connectors) such as computer 12. The switch circuit 43 is connecting between the memory card connector 41 and the USB connector 42. As shown in FIG. 2, because the memory device 20 of this invention supports both the USB interface and the memory card interface, the flash memory card adaptor 40 needs not to have a USB to memory card interfaces converting circuit. The flash memory card adaptor 40 only needs to electrically connect to corresponding pins. Therefore, this invention can reduce the cost of the flash memory card adapter 40.

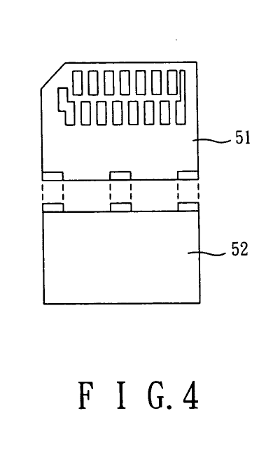

FIG. 4 shows an appearance diagram of Reduce MMC 51 (RS MMC). The size of the RS MMC 51 is roughly equal to the size of the front half of the conventional MMC. The RS MMC 51 contains 13 pins and is still compatible with the connection pins of the conventional MMC. While connecting the RS MMC 51 with a conventional MMC card reader, the rear half 52 of the body is added so the size of the RS MMC 51 will be the same with the conventional MMC. Therefore, the memory device with dual interface auto-switch circuit can also apply in the RS MMC 51.

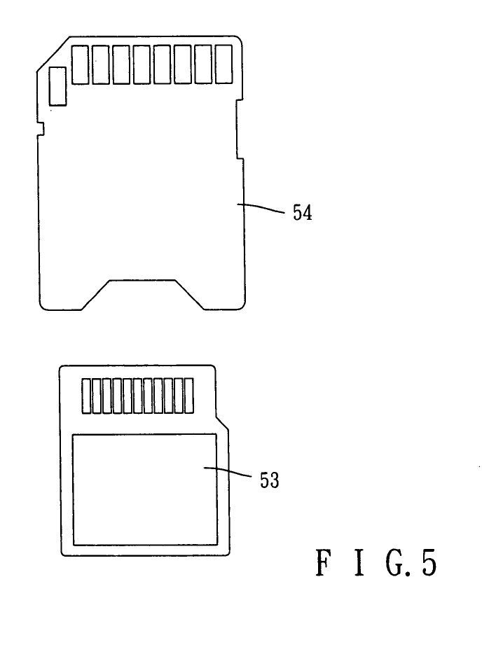

FIG. 5 shows an appearance diagram of mini SD Card 53. The mini SD 53 is smaller than the conventional SD. Therefore, it cannot be directly connected to the conventional SD card reader. However, the communication protocol of the mini SD 53 is compatible with the conventional SD. Therefore, if the mini SD 53 is plugged the SD card adaptor 43, the size would be the same as the size of the conventional SD. Thus, the mini SD 53 can communicate with the conventional SD card reader. Therefore, the memory device with dual interface auto-switch circuit can also apply to the mini SD.

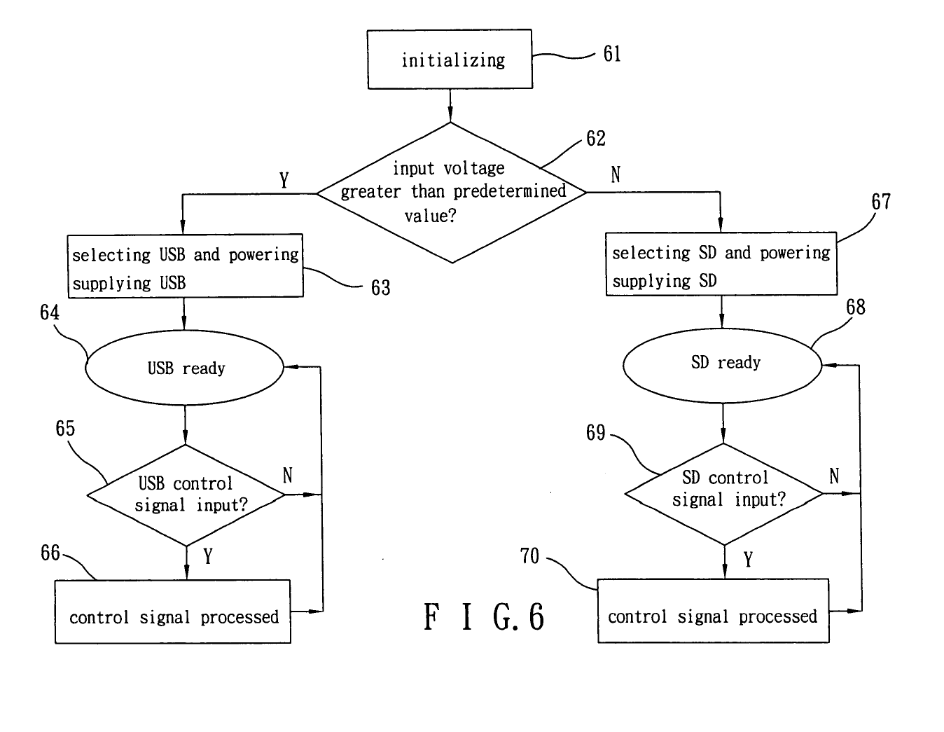

FIG. 6 shows a flowchart of an embodiment of the switching method of the dual interface auto-switch circuit of this invention. The method of the present invention includes the steps of:

Step 61 is the initializing step. In this step, the memory device 20 of the invention which contains the dual interface auto-switch circuit is connecting with, or plugging in, an external device 90 and receiving an input voltage (VBUS/VDD) from the external device 90.

In step 62, the received input voltage is checked to determine if it is greater than a predetermined value. If it is greater than the predetermined value, the step 63 is then executed. If it is not greater than the predetermined value, the step 67 is then executed.

In step 63, the USB is selected and the power is supplied to the USB interface. In other words, the first switch 325 is turned on and power is supplied to the first communication interface circuit 323.

In step 64, the USB is ready.

In step 65, it is checking if there is any USB control signal inputted. If it is, the step 66 is then executed. If it is not, the step 64 is then executed.

In step 66, the USB control signal is processed and the operation the memory device 20 of the invention responds to the USB control signal.

In step 67, the SD bus is selected and the power is supplied to the SD interface. In other words, the second switch 326 is turned on and power is supplied to the second communication interface circuit 324.

In step 68, the SD bus is ready.

In step 69, it is checking if there is any SD control signal inputted. If it is, the step 70 is then executed. If it is not, the step 68 is then executed.

In step 71, the SD control signal is processed and the operation the memory device 20 of the invention responds to the SD control signal.

In the following embodiments, most of the components and steps are the same as or similar to the embodiments described previously. Therefore, the same or similar components or steps will be named the same and the detail descriptions will not be repeated.

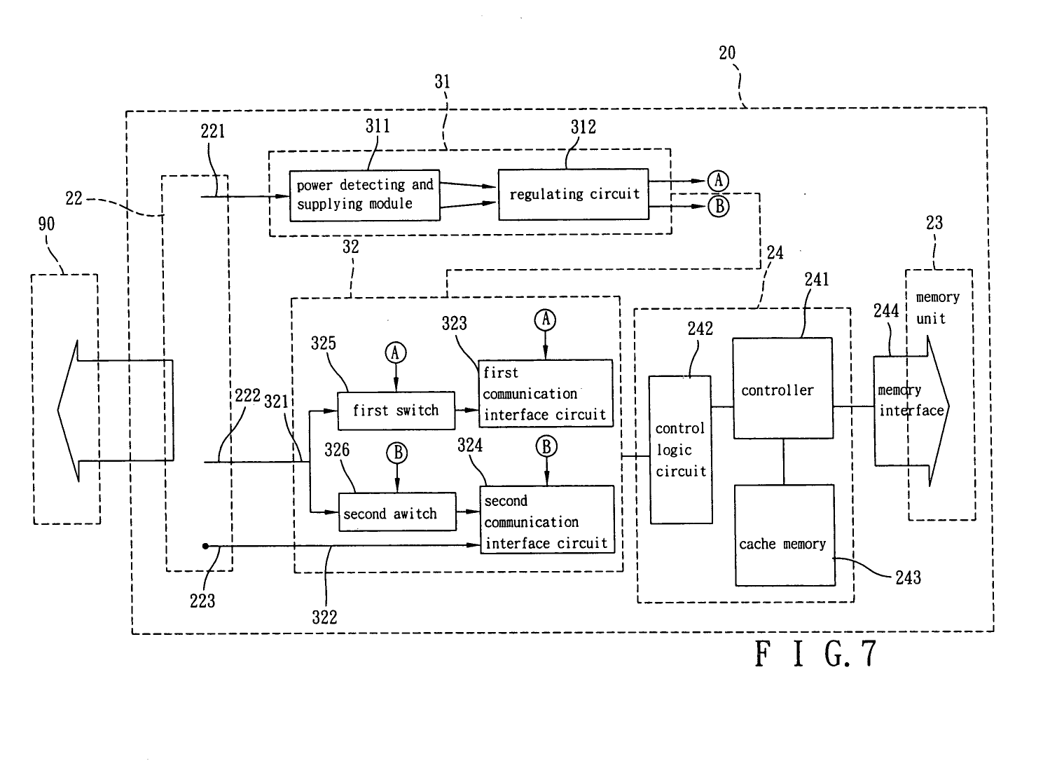

FIG. 7 illustrates a block diagram of a second embodiment of a dual-interfaces auto-switch circuit according to the present invention. The memory device 20 in FIG. 7 also comprises a body 21, a plurality of connection pins 22, a memory unit 23, a control unit 24, and the dual interface auto-switch circuit of this invention. The dual interface auto-switch circuit comprises a power detecting and supplying module 31 and interface switch circuit 32. The embodiment in FIG. 7 is different from the previous embodiment due to that the power detecting and supplying module 31 in FIG. 7 also comprises a power detecting circuit 311 and a regulating circuit 312. The power detecting circuit 311 can compare the received voltage with a predetermined value and transform the received voltage into either the first power signal A or the second power signal B according to the result of comparison. Through the regulating circuit 3 12, the voltage supplied to the interface switch circuit 32 is stable and the first power signal A and the second power signal B can be different from the input voltage of the external device.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. A multi-interface auto-switch circuit located in a memory device, the memory device comprising a first communication interface and a second communication interface for communicating with an external device, the multi-interface auto-switch circuit comprising:
a power detecting and supplying module for receiving and detecting a power voltage of the external device, and producing a voltage signal according to the power voltage of the external device; and
an interface switch module, coupled to the power detecting and supplying module, for receiving the voltage signal from the power detecting and supplying module, and controlling the connection between the external device and one of the first communication interface and the second communication interface according to the voltage signal.

2. The multi-interface auto-switch circuit as set forth in claim 1, wherein the power detecting and supplying module further comprises:
a voltage detector for comparing the power voltage form the external device with a predetermined voltage, and outputting a comparison result; and
a regulating circuit, coupled to the voltage detector, for regulating the power voltage into a first power voltage and a second power voltage, and outputting the first power voltage or the second power voltage as the voltage signal according to the comparison result.

3. The multi-interface auto-switch circuit as set forth in claim 1, wherein the interface switch module further comprises:
a plurality of shared signal lines coupled to the external device and the first and the second communication interfaces, wherein each of the first and second communication interfaces communicates with the external device through the shared signal lines;
a plurality of non-shared signal lines coupled to the external device and the second communication interface, wherein the second communication interfaces communicates with the external device through the non-shared signal lines;
a first communication interface circuit for processing the data of the first communication interface;
a second communication interface circuit, coupled to the non-shared signal lines, for processing the data of the second communication interface;
a first switch circuit, coupled between the shared signal lines and the first communication interface circuit, for controlling the connection of the shared signal lines and the first communication interface circuit according to the voltage signal of the power detecting and supplying module; and
a second switch circuit, coupled between the shared signal lines and the second communication interface circuit, for controlling the connection of the shared signal lines and the second communication interface circuit according to the voltage signal of the power detecting and supplying module;
wherein only one of the first switch circuit and the second switch circuit is turned on at the same time.

4. The multi-interface auto-switch circuit as set forth in claim 3, wherein the voltage signal comprises a first power voltage signal and a second power voltage signal, the first switch circuit receives the first power voltage signal and turns on or off according to the first power voltage signal, the second switch circuit receives the second power voltage signal and turns on or off according to the second power voltage signal, and either the first switch circuit or the second switch circuit is turned on.

5. The multi-interface auto-switch circuit as set forth in claim 4, wherein the first power signal connects to the first communication interface and supplies power to the first communication interface, and the second power signal connects to the second communication interface and supplies the power to the second communication interface, wherein only one of the first communication interface and the second communication interface has power supply at the same moment.

6. The multi-interface auto-switch circuit as set forth in claim 1, wherein the first communication interface is a Universal Serial Bus (USB) interface, and the second communication interface is a Secure Digital (SD) interface.

7. The multi-interface auto-switch circuit as set forth in claim 1, wherein the memory device is a flash memory card which comprises a Universal Serial Bus (USB) and Secure Digital (SD) interfaces.

8. A memory device with multi-interface auto-switch circuit comprising:
a body;
a plurality of pins disposed on a first side of the body, the pins comprising a power source pin;
a memory unit located at the body for storing data;
a control unit, located at the body and coupled to the memory unit, for accessing the data stored in the memory unit and communicating with an external device through the pins;
a power detecting and supplying module, coupled to the power source pin, for receiving and detecting a power voltage of the external device, and producing a voltage signal according to the power voltage, and
an interface switch module, coupled to the power detecting and supplying module and coupled between the control unit and the pins, for receiving the voltage signal from the power detecting and supplying module, and controlling the connection between the external device and one of the first communication interface and the second communication interface through the pins according to the voltage signal from the power detecting and supplying module.

9. The memory device with multi-interface auto-switch circuit as set forth in claim 8, wherein the power detecting and supplying module further comprises:
a voltage detector for comparing the received voltage form the external device with a predetermined voltage, and outputting a comparison result; and
a regulating circuit, coupled to the voltage detector, for regulating the received voltage into a first power voltage and a second power voltage, and outputting the first power voltage or the second power voltage as the voltage signal according to the comparison result.

10. The memory device with multi-interface auto-switch circuit as set forth in claim 8, wherein the interface switch module further comprises:
a plurality of shared signal lines coupled to the external device, the first communication interface, and the second communication interface, wherein each of the first and second communication interfaces communicates with the external device through the shared signal lines;
a plurality of non-shared signal lines coupled to the external device and the second communication interface, wherein the second communication interfaces communicates with the external device through the non-shared signal lines;
a first communication interface circuit for processing the data of the first communication interface;
a second communication interface circuit, coupled to the non-shared signal lines, for converting the data of the second communication interface into for the control unit;
a first switch circuit, coupled between the shared signal lines and the first communication interface circuit, for controlling the connection of the shared signal lines and the first communication interface circuit according to the voltage signal from the power detecting and supplying module; and
a second switch circuit, coupled between the shared signal lines and the second communication interface circuit, for controlling the connection of the shared signal lines and the second communication interface circuit according to the voltage signal from the power detecting and supplying module;
wherein only one of the first switch circuit and the second switch circuit is turned on at the same time.

11. The memory device with multi-interface auto-switch circuit as set forth in claim 10, wherein the voltage signal comprises the first power voltage and the second power voltage, the first switch circuit receives the first power voltage and turns on or off according to the first power voltage, the second switch circuit receives the second power voltage and turns on or off according to the second power voltage, and either the first switch circuit or the second switch circuit is turned on at the same moment;

12. The memory device with multi-interface auto-switch circuit as set forth in claim 11, wherein the first power signal connects to the first communication interface and supplies power to the first communication interface, and the second power signal connects to the second communication interface and supplies the power to the second communication interface, wherein only one of the first communication interface and the second communication interface has power supply at the same moment.

13. The memory device with multi-interface auto-switch circuit as set forth in claim 8, wherein the first communication interface is a Universal Serial Bus (USB) interface, the second communication interface is a Secure Digital (SD) interface, and the pins are compatible with the standard of the SD.

14. The memory device with multi-interface auto-switch circuit as set forth in claim 8, wherein the memory device is a flash memory card with Universal Serial Bus (USB) and Secure Digital (SD) interfaces, and the pins are compatible with the standard of the SD.

15. The memory device with multi-interface auto-switch circuit as set forth in claim 8, further comprising:
an adapter module comprising:
a first connector for connecting to the memory device and electrically coupling with the pins,
a second connector for connecting to a USB interface of an external device; and
a switching circuit connected to the first connector and the second connector.

16. A multi-interface auto-switching method for automatically switching communication interfaces of a memory device, the memory device having at least a first communication interface and a second communication interface and communicating with an external device, the method comprising:
receiving a power voltage from the external device;
comparing the power voltage with a predetermined value to generate a comparison result; and
controlling the connection between the external device and one of the first communication interface and the second communication interface according to the comparison result,
wherein the first communication interface is connected to the external device when the power voltage is greater than the predetermined value;
wherein the second communication interface is connected to the external device when the power voltage is less then the predetermined value.

17. The method as set forth in claim 16, wherein the first communication interface is a Universal Serial Bus (USB) interface, and the second communication interface is a Secure Digital (SD) interface.

18. The method as set forth in claim 16, wherein while one of the communications interface is connecting to the external device, the other communication is grounded;

19. The method as set forth in claim 16, wherein the predetermined value is approximately between 3.3 and 5.0 voltage.

20. The method as set forth in claim 19, wherein the predetermined value is approximately 4.2 voltage.
